(19) United States
(12) Patent Application Publication
(10) Pub. No.: US 2019/0364366 A1
(43) Pub. Date: Nov. 28, 2019

(54) ELECTROACOUSTIC CONVERTER

(71) Applicant: ALPINE ELECTRONICS, INC., Tokyo (JP)

(72) Inventors: Kei Tanabe, Iwaki-shi (JP); Ryo Ito, Iwaki-shi (JP)

(73) Assignee: ALPINE ELECTRONICS, INC., Tokyo (JP)

(21) Appl. No.: 16/381,647

(22) Filed: Apr. 11, 2019

(30) Foreign Application Priority Data
May 23, 2018 (JP) 2018-099209

(51) Int. Cl. H04R 7/18; H04R 9/02; H04R 7/26; H04R 7/12

(52) U.S. Cl. CPC H04R 7/18; H04R 7/127; H04R 7/26; H04R 9/025

(57) ABSTRACT

In an electroacoustic converter, a dome-shaped diaphragm having anisotropy in rigidity is formed by shaping fiber reinforced plastic having anisotropy in fiber orientation. A voice coil bobbin, in a hollow cylindrical shape, on which a voice coil is wound is linked to the outer edge of the diaphragm so that the shape of the linked portion becomes circular when viewed in the axial direction of the diaphragm. The diaphragm vibrates due to an electromagnetic action by a magnetic flux that is generated in a magnetic circuit and flows in the voice coil and the current of an audio signal flowing in the voice coil.

### RELATED APPLICATION

The present application claims priority to Japanese Patent Application Number 2018-099209, filed May 23, 2018, the entirety of which is hereby incorporated by reference.

### BACKGROUND

### 1. Field of the Invention

The present invention relates to a technology that improves the sound quality of an electroacoustic converter.

### 2. Description of the Related Art

A speaker known as an electroacoustic converter suppresses the sharpening of a resonance peak in a high-frequency range by using a diaphragm having anisotropy in rigidity (see Japanese Patent No. 6275297, for example).

The diaphragm in this speaker is manufactured by shaping a single seamless sheet that has a structure in which a filler having shape anisotropy is dispersed in a resin with the longitudinal axis of the filler being oriented in one predetermined direction.

This speaker is a cone-type speaker that has a diaphragm in a cone shape. When an audio signal is applied to a voice coil wound on a voice coil bobbin linked to an end of the diaphragm on the inner circumferential side, a magnetic flux generated by a magnetic circuit passes through the voice coil. Due to an electromagnetic action by the audio signal and the magnetic flux, the diaphragm vibrates through the voice coil bobbin, generating a sound.

This speaker makes it possible to suppress the sharpening of a resonance peak, that is, distributes resonance, to suppress the generation of unnecessary sounds different from the original sound, and to reproduce a sound closer to the original sound.

### SUMMARY

Although the speaker, described above, that uses a diaphragm having anisotropy in rigidity has the effect of improving sound quality due to resonance distribution, the speaker is problematic in that the diaphragm is likely to generate vibration in a non-axisymmetric mode and the vibration may cause relatively large distortion in an output sound.

The present disclosure addresses the above problem with an object of suppressing the generation of vibration in a non-axisymmetric mode in an electroacoustic converter having anisotropy in rigidity without losing the effect of improving sound quality due to resonance distribution.

To achieve the above object, in the present disclosure, an electroacoustic converter that performs conversion between an electric signal and an acoustic signal includes: diaphragm having anisotropy in rigidity, the diaphragm being formed by shaping a fiber reinforced sheet having anisotropy in fiber orientation; a voice coil bobbin having a ring-shaped end fastened to the outer edge of the diaphragm so that the ring-shaped end encloses the inside of the outer edge of the diaphragm when viewed in the axial direction of the diaphragm; a voice coil wound on the voice coil bobbin; and a magnetic circuit that generates a magnetic flux that passes through the voice coil.

Since, in this electroacoustic converter, the ring-shaped end of the voice coil bobbin is fastened to the outer edge of the diaphragm so that the ring-shaped end encloses the inside of the outer edge of the diaphragm when viewed in the axial direction of the diaphragm, the voice coil bobbin can effectively reinforce the diaphragm and can increase the rigidity of the diaphragm in a direction in which the rigidity of the diaphragm would otherwise be small. Therefore, it is possible to obtain the effect of improving sound quality due to resonance distribution and to suppress the vibration of the diaphragm in a non-axisymmetric mode.

When the voice coil bobbin drives the outer edge of the diaphragm, it is possible to make the motion of the whole of the diaphragm follow the motion of the voice coil bobbin more faithfully. Therefore, the generation of the vibration of the diaphragm in a non-axisymmetric mode can be suppressed.

In the present disclosure, the outer circumferential end of the diaphragm may be shaped as a rib that is bent in a direction that does not follow the plane of a portion inside the outer circumferential end of the diaphragm.

Since, in this electroacoustic converter, the outer circumferential end of the diaphragm is shaped as a rib, the rigidity of the diaphragm can be increased in a direction in which the rigidity would otherwise be small. Therefore, it is possible to obtain the effect of improving sound quality due to resonance distribution and to suppress the vibration of the diaphragm in a non-axisymmetric mode.

In the present disclosure, a damping member may be provided so as to be secured to a surface of the diaphragm, the damping member having a ring shape centered at the axis of the diaphragm when viewed in the axial direction of the diaphragm.

In this electroacoustic converter, the damping member fastened to the diaphragm can attenuate vibration in a direction in which the rigidity of the diaphragm is small and can suppress the vibration of the diaphragm in a non-axisymmetric mode. Since the ring-shaped damping member is disposed so as to be coaxial with the diaphragm, the damping member can also absorb and suppress the vibration of the diaphragm in a non-axisymmetric mode without generating other different non-axisymmetric vibration.

The electroacoustic converter described above may be a speaker that converts an electric signal to an acoustic signal.

As described above, embodiments of the present invention can suppress the generation of vibration in a non-axisymmetric mode in an electroacoustic converter that uses a diaphragm having anisotropy in rigidity.

Each aspect described above can also be applied similarly to a case in which the shape of the diaphragm is not in a dome shape.

Besides speakers that convert an electric signal to an acoustic signal, each aspect described above can be applied similarly to other electroacoustic converters, such as a microphone, that convert an acoustic signal to an electric signal.

### BRIEF DESCRIPTION OF THE DRAWINGS

FIGS. 1A, 1B, 1C, 1D, and 1E illustrate a speaker according a first embodiment of the present invention;

FIGS. 2A, 2B, 2C, and 2D illustrate a speaker according a second embodiment of the present invention; and

FIGS. 3A, 3B, 3C, 3D, and 3E1 to 3E3 illustrate a speaker according a third embodiment of the present invention.

### DETAILED DESCRIPTION OF THE PREFERRED EMBODIMENTS

Hereinafter, embodiments will be described with reference to the accompanying drawings. Note that components having substantially the same functional configuration are denoted by the same reference numeral, and therefore, a redundant description thereof is omitted.

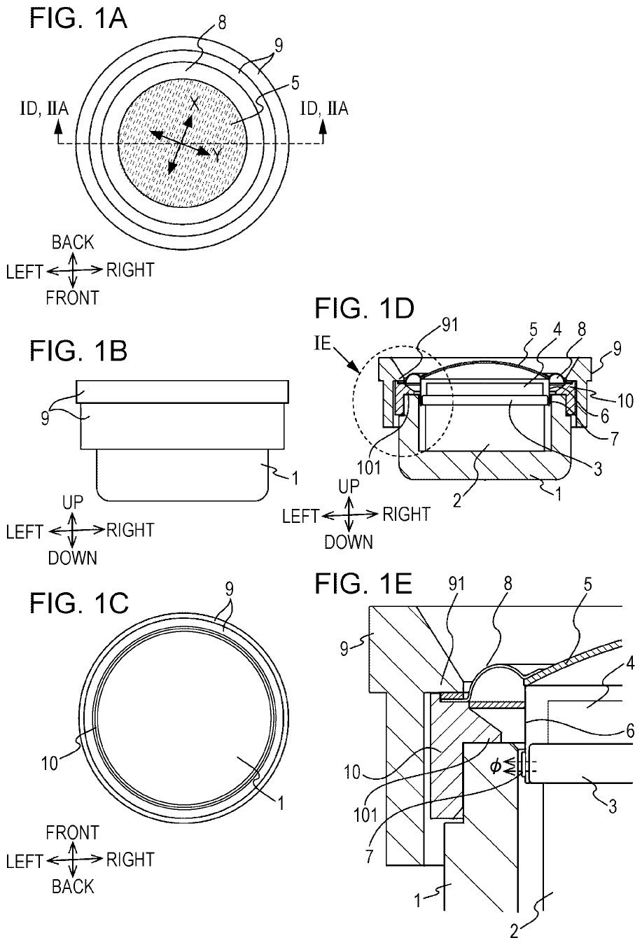

FIGS. 1A, 1B, 1C, 1D, and 1E illustrate a speaker according to a first embodiment of the present invention.

For convenience, assuming that the up, down, front, back, left, and right directions of the speaker are defined as in the drawings, FIG. 1A illustrates the top of the speaker, FIG. 1B illustrates the front of the speaker, FIG. 1C illustrates the bottom of the speaker, and FIG. 1D is a cross-sectional view taken along line 1D, IIA-1D, IIA in FIG. 1A. FIG. 1E is an enlarged view of portion IE in the cross-sectional view in FIG. 1D.

As illustrated in the drawings, the speaker has a yoke 1 in a circular tubular shape that has a bottom at the lower end and an opening at the upper end, a magnet 2 in a disc shape that is secured to the bottom of the yoke 1 on the inner side, and a top plate 3 in a disc shape that is placed on the magnet 2. The yoke 1, magnet 2, and top plate 3 form a magnetic circuit together. A sub-magnet 4 is provided on the top plate 3. The magnetic field of the sub-magnet 4 is in a direction in which the sub-magnet 4 repels the magnet 2, so the sub-magnet 4 works to increase the density of a magnetic flux extending from the top plate 3 toward a magnetic gap.

The speaker also has a diaphragm 5 in a dome shape, a voice coil bobbin 6 in a hollow cylindrical shape, a voice coil 7 wound on the voice coil bobbin 6, an edge 8, a top frame 9 in a circular tubular shape that has an inner flange 91 at the upper end, and a sub-frame 10 in a circular tubular shape that has an inner flange 101 at the upper end.

The sub-frame 10 is secured to the yoke 1 so as to enclose the opening of the yoke 1, the opening being formed at the upper end, when viewed vertically in a state in which the lower surface of the inner flange 101 is placed on the upper end of the yoke 1 along its circumference. The top frame 9 is secured to the sub-frame 10 so as to enclose the opening of the sub-frame 10 when viewed vertically in a state in which the lower surface of the inner flange 91 is placed on the upper end of the sub-frame 10 along its circumference.

The outer circumferential edge of the diaphragm 5 is linked to the inner circumferential edge of the edge 8. The outer circumferential edge of the edge 8 is secured to the yoke 1 in a state in which the outer circumferential edge is sandwiched between the top frame 9 and the sub-frame 10.

The upper end of the voice coil bobbin 6 is fastened to the outer circumferential end of the diaphragm 5 so that the voice coil bobbin 6 extends downward. The inner side of the outer circumferential end of the diaphragm 5 is inside the voice coil bobbin 6 when viewed vertically.

The voice coil 7 wound on the voice coil bobbin 6 is placed in a space through which a magnetic flux ϕ generated by the magnetic circuit passes, the space being formed between the yoke 1 and the outer circumferential surface of the top plate 3.

When an audio signal is applied to the voice coil 7, the voice coil bobbin 6 and diaphragm 5 vibrate vertically due to an electromagnetic action by the magnetic flux generated from the magnetic circuit and the audio signal flowing in the voice coil 7, according to the amplitude of the audio signal. This causes a sound to be generated from the diaphragm 5 according to the audio signal.

The diaphragm 5 is manufactured by performing, for example, bending or vacuum forming to form a sheet-like raw material having anisotropy in rigidity into a dome shape. At first glance, a diaphragm made of this type of material appears to be ill-balanced. However, the diaphragm makes it possible to suppress the sharpening of a resonance peak, that is, distribute resonance, to suppress the generation of unnecessary sounds different from the original sound, and to reproduce a sound closer to the original sound.

As this type of sheet-like raw material having anisotropy in rigidity, a sheet made of carbon fiber reinforced plastic (CFRP) in which the orientations of carbon fibers are the same or a sheet made of fiber reinforced plastic (FRP) such as glass fiber reinforced plastic (GFRP), for example, can be used. This type of sheet made of fiber reinforced plastic has large rigidity in a direction in which fibers are oriented and small rigidity in a direction perpendicular to the orientation of the fibers.

Therefore, if, on the diaphragm 5, the direction in which fibers are oriented is the X direction as illustrated in FIG. 1A, rigidity in the X direction is large and rigidity in the Y direction, which is perpendicular to the X direction, is small. As a result, if the diaphragm is used independently, the diaphragm is likely to cause non-axisymmetric vibration that propagates in the Y direction.

In the first embodiment, however, the voice coil bobbin 6 is fastened to the outer circumferential end of the diaphragm 5. Therefore, the voice coil bobbin 6 can effectively reinforce the diaphragm 5, making it possible to increase the rigidity of the diaphragm 5 in a direction in which the rigidity of the diaphragm 5 would otherwise be small and to suppress the vibration of the diaphragm 5 in a non-axisymmetric mode.

When the voice coil bobbin 6 drives the outer circumferential end of the diaphragm 5, it becomes possible to make the motion of the whole of the diaphragm 5 follow the motion of the voice coil bobbin 6 more faithfully. Therefore, the generation of the vibration of the diaphragm 5 in a non-axisymmetric mode can be suppressed.

The effect of resonance distribution is obtained by the property of the material. Therefore, the effect is not lost even when the diaphragm 5 is reinforced as described above. As a result, both resonance distribution and suppression of non-axisymmetric vibration can be achieved.

It can also be considered that a voice coil bobbin is fastened to the center of a diaphragm and use another cylindrical part or the like as a means for reinforcing the outer edge of the diaphragm. However, the weight is increased and vibration becomes difficult in a high-frequency band. By contrast, in this embodiment, the voice coil bobbin 6 is used as a reinforcing means, so an increase in weight can be suppressed. This prevents properties from being lowered in a high-frequency band.

A second embodiment of the present invention will be described below. A speaker in the second embodiment differs from the speaker in the first embodiment illustrated in FIGS. 1A to 1E in that rib forming is performed so that the outer circumferential edge of the diaphragm 5 is bent to form a ring-shaped rib at the outer circumferential end of the diaphragm 5.

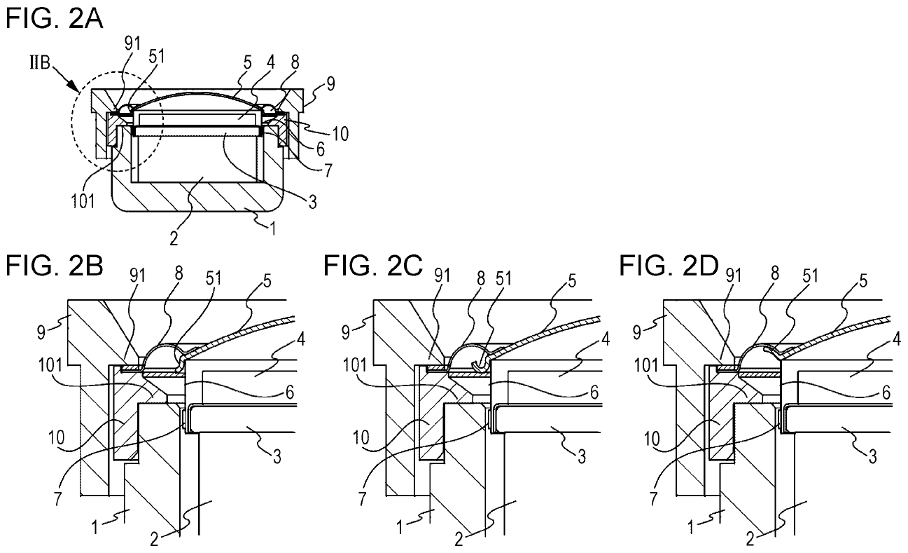

Specifically, in the second embodiment, the outer circumferential end of the diaphragm 5 extends outward from a linkage with the edge 8 as illustrated in FIG. 2B, which is an enlarged view of portion IIB in a cross-sectional view in FIG. 2A as taken along line ID, IIA-ID, IIA in FIG. 1A. To form a rib 51 outside the linkage with the edge 8, the outer portion extending outward from the linkage is bent in a direction that does not follow the dome shape of the diaphragm 5 by taking a single circle or each of a plurality of circles with different radii, the single circle or the plurality of circles being centered at the axis of the diaphragm 5 in a dome shape, as a bending line, when viewed in the vertical direction.

The rib 51 disposed as described above can have a shape illustrated in, for example, FIG. 2C and other various shapes, besides the shapes illustrated in FIGS. 2A and 2B.

The rib 51 does not necessarily have to be disposed outside the linkage with the edge 8. For example, the rib 51, in a ring shape, of the diaphragm 5 may be used as a linkage that links the diaphragm 5 and edge 8 together, as illustrated in FIG. 2D.

Since, in the second embodiment, the outer circumferential end of the diaphragm 5 is formed as the rib 51, it possible to increase the rigidity of the diaphragm 5 in a direction in which the rigidity of the diaphragm 5 would otherwise be small and to suppress the vibration of the diaphragm 5 in a non-axisymmetric mode.

It is also possible to use the rib 51 to have the voice coil bobbin 6 and diaphragm 5 abut each other in a wider contact area at the linkage between the voice coil bobbin 6 and the diaphragm 5, as illustrated in, for example, FIG. 2D. When the abutting portions are bonded together, the strength of the linkage between the voice coil bobbin 6 and diaphragm 5 can be increased.

A third embodiment will be described below. A speaker in the third embodiment differs from the speaker in the first embodiment illustrated in FIGS. 1A to 1E in that a ring-shaped damper is fastened to the diaphragm 5.

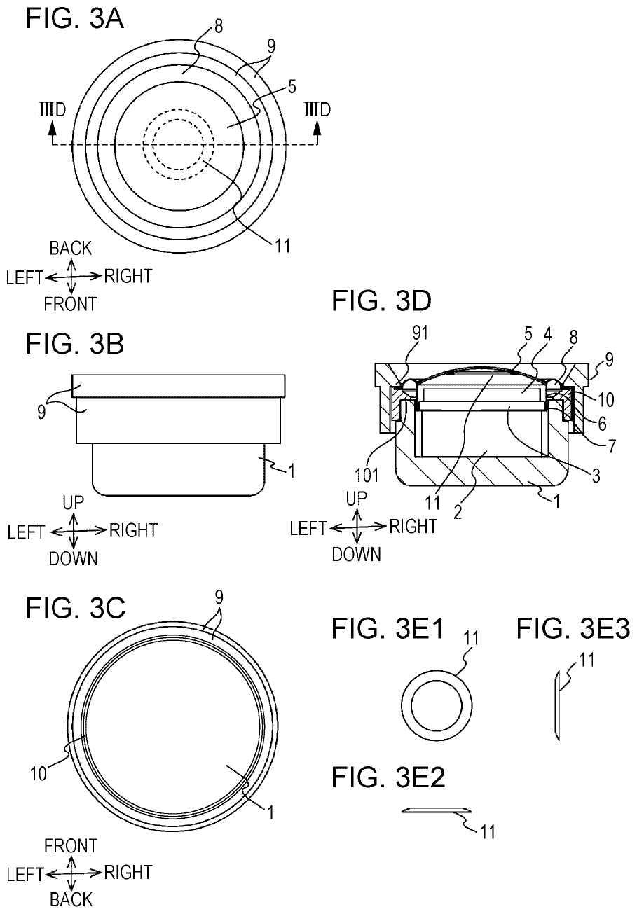

Specifically, in the third embodiment, a damper 11 in a ring shape is fastened to the lower surface of the diaphragm 5 at a position circumferentially inside the edge 8 with an adhesive or the like so as to be coaxial with the diaphragm 5, as illustrated in FIG. 3A representing the top of the speaker, FIG. 3B representing the front of the speaker, FIG. 3C representing the bottom of the speaker, and FIG. 3D representing a cross-sectional view along line IIID-IIID in FIG. 3A.

The damper 11 is a member formed by using a raw material having rigidity and a vibration absorbing property such as a hard rubber.

The damper 11 is ring-shaped when viewed vertically, and its upper surface and lower surface are curved so as to follow the curve of the lower surface of the dome, as illustrated in FIG. 3E1 representing the top of the damper 11, FIG. 3E2 representing the front of the damper 11, and FIG. 3E3 representing the right side of the damper 11.

In the third embodiment, the damper 11 fastened to the diaphragm 5 can attenuate vibration in a direction in which the rigidity of the diaphragm 5 is small and can suppress the vibration of the diaphragm 5 in a non-axisymmetric mode. Since the damper 11 in a ring shape is disposed so as to be coaxial with the diaphragm 5, the damper 11 can also absorb and suppress the vibration of the diaphragm 5 in a non-axisymmetric mode without generating other, different non-axisymmetric vibration.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. An electroacoustic converter that performs conversion between an electric signal and an acoustic signal, the converter comprising:
a diaphragm having anisotropy in rigidity, the diaphragm being formed by shaping a fiber reinforced sheet having anisotropy in fiber orientation;
a voice coil bobbin having a ring-shaped end fastened to an outer edge of the diaphragm so that the ring-shaped end encloses an inside of the outer edge of the diaphragm when viewed in an axial direction of the diaphragm;
a voice coil wound on the voice coil bobbin; and
a magnetic circuit that generates a magnetic flux that passes through the voice coil.

2. The electroacoustic converter according to claim 1, wherein an outer circumferential end of the diaphragm is shaped as a rib that is bent in a direction that does not follow a plane of a portion inside the outer circumferential end of the diaphragm.

3. The electroacoustic converter according to claim 1, further comprising a damping member secured to a surface of the diaphragm, the damping member having a ring shape centered at an axis of the diaphragm when viewed in the axial direction of the diaphragm.

4. The electroacoustic converter according to claim 1, wherein the electroacoustic converter is a speaker that converts an electric signal to an acoustic signal.

5. The electroacoustic converter according to claim 1, wherein an outer circumferential edge of the diaphragm is linked to an inner circumferential edge of an annular edge, the annular edge having a cross-sectional shape comprising a curve.

6. The electroacoustic converter according to claim 5, wherein the diaphragm has a dome shape.

7. An electroacoustic converter that performs conversion between an electric signal and an acoustic signal, the converter comprising:
a diaphragm having anisotropy in rigidity;
a voice coil bobbin having a ring-shaped end fastened to an outer edge of the diaphragm so that the ring-shaped end encloses an inside of the outer edge of the diaphragm when viewed in an axial direction of the diaphragm;
a voice coil wound on the voice coil bobbin; and
a magnetic circuit that generates a magnetic flux that passes through the voice coil;
wherein an outer circumferential end of the diaphragm is shaped as a rib that is bent in a direction that does not follow a plane of a portion inside the outer circumferential end of the diaphragm.

8. The electroacoustic converter according to claim 7, further comprising a damping member secured to a surface of the diaphragm, the damping member having a ring shape centered at an axis of the diaphragm when viewed in the axial direction of the diaphragm.

9. The electroacoustic converter according to claim 7, wherein the electroacoustic converter is a speaker that converts an electric signal to an acoustic signal.

10. The electroacoustic converter according to claim 7, wherein an outer circumferential edge of the diaphragm is linked to an inner circumferential edge of an annular edge, the annular edge having a cross-sectional shape comprising a curve.

11. The electroacoustic converter according to claim 10, wherein the rib circumferentially overlaps a portion of the annular edge.

12. The electroacoustic converter according to claim 7, wherein the diaphragm has a dome shape.

13. An electroacoustic converter that performs conversion between an electric signal and an acoustic signal, the converter comprising:
a diaphragm having anisotropy in rigidity;
a voice coil bobbin having a ring-shaped end fastened to an outer edge of the diaphragm so that the ring-shaped end encloses an inside of the outer edge of the diaphragm when viewed in an axial direction of the diaphragm;
a voice coil wound on the voice coil bobbin;
a magnetic circuit that generates a magnetic flux that passes through the voice coil; and
a damping member secured to a surface of the diaphragm, the damping member having a ring shape centered at an axis of the diaphragm when viewed in the axial direction of the diaphragm.

14. The electroacoustic converter according to claim 13, wherein an outer circumferential end of the diaphragm is shaped as a rib that is bent in a direction that does not follow a plane of a portion inside the outer circumferential end of the diaphragm.

15. The electroacoustic converter according to claim 14, wherein the rib circumferentially overlaps a portion of the voice coil bobbin at the ring-shaped end.

16. The electroacoustic converter according to claim 13, wherein the electroacoustic converter is a speaker that converts an electric signal to an acoustic signal.

17. The electroacoustic converter according to claim 13, wherein an outer circumferential edge of the diaphragm is linked to an inner circumferential edge of an annular edge, the annular edge having a cross-sectional shape comprising a curve.

18. The electroacoustic converter according to claim 17, wherein the diaphragm has a dome shape.
